(19) United States
(12) Patent Application Publication
(10) Pub. No.: US 2012/0283890 A1
(43) Pub. Date: Nov. 8, 2012

(54) Control Apparatus for Micro-grid Connect/Disconnect from Grid

(75) Inventors: Meiping Fu, Beijing (CN); Jianrong Mao, Beijing (CN); Hongwei Ma, Beijing (CN)

(73) Assignees: STATE GRID CORPORATION OF CHINA (SGCC), Beijing (CN); China Electric Power Equipment and Technology Co. Ltd., Beijing (CN)

(21) Appl. No.: 13/463,665

(22) Filed: May 3, 2012

(30) Foreign Application Priority Data
May 5, 2011 (CN) 201120140032.3

(51) Int. Cl. G06F 1/28; G06F 1/26

(52) U.S. Cl. 700/295; 700/286

(57) ABSTRACT

A micro-grid controller comprises a sampling unit, a processor and an input and output unit. The processor generates a micro-grid operation control command based upon the system operational parameters detected by the sampling unit. Through the input and output unit, the micro-grid controller is able to disconnect the micro-grid system from a main grid system by turning off a switch coupled between the micro-grid system and the main grid system.

This application claims priority to Chinese Application No. 201120140032.3, filed on May 5, 2011, which is incorporated herein by reference in its entirety.

### BACKGROUND

A micro-grid system is a discrete power system including a variety of interconnected power generators, energy storage units and loads. In comparison with a main power utility grid, a micro-grid system is of a clearly defined zone. In addition, the micro-grid system functions a single entity. In response to the needs of its loads, the micro-grid system is capable of connecting to the main power utility grid. The grid connected operation of a micro-grid system is alternatively referred to as a grid connected mode. On the other hand, in response to the system needs or abnormal operation conditions such as power outages at the main power utility grid, the micro-grid system is capable of disconnecting from the main power utility grid. The grid disconnected operation is commonly known as an islanded mode.

The micro-grid system may comprise a plurality of power generators, which could utilize different technologies such as solar energy sources (e.g., solar panels), wind generators (e.g., wind turbines), combined heat and power (CHP) systems, marine energy, geothermal, biomass, fuel cells, micro-turbines and the like. Due to the nature of renewable energy, in order to provide reliable and stable power to critical loads, the micro-grid system may include a plurality of power storage units such as utility-scale energy storage systems, batteries and the like. The power generators, energy storage systems and loads are interconnected each other to be collectively treated by the main grid as a controllable micro grid.

The micro-grid system may be coupled to a main grid through switches such as circuit breakers. A controller comprising hardware and software systems may be employed to control and manage the micro-grid system. Furthermore, the controller is able to control the on and off state of the circuit breakers so that the micro-grid system can be connected to or disconnected from the main grid accordingly.

The micro-grid system has a variety of advantages. Micro-grid systems can improve energy efficiency and reduce power losses by locating power sources close to their loads. In addition, micro-grid systems may improve service quality and reliability. Lastly, micro-grid systems may reduce greenhouse gases and pollutant emissions.

### SUMMARY OF THE INVENTION

These and other problems are generally solved or circumvented, and technical advantages are generally achieved, by preferred embodiments of the present invention which provide an apparatus for managing a micro-grid system coupled to a main grid system during a system fault.

In accordance with an embodiment, an apparatus comprises a sampling unit configured to detect operational parameters of a main grid system and a micro-grid system, a processor coupled to the sampling unit, wherein the processor is configured to receive the operational parameters of the main grid system and the micro-grid system, generate a control signal for the micro-grid system in consideration with planned islanded operation, unplanned islanded operation, system faults, short circuit, over current and reverse power flow and forward the control signal to a driver of a switch coupled between the main grid system and the micro-grid system.

The apparatus may further comprise an input and output unit coupled to the processor, wherein the input and output unit is configured to detect an operating status of the switch, forward the operating status to the processor and execute a control command from the processor.

In accordance with another embodiment, a system comprises a local voltage bus coupled to a main grid system through a switch, a plurality of power generators coupled to the local voltage bus, a plurality of power storage units coupled to the local voltage bus, a first sensor coupled to a main grid voltage bus, wherein the main grid voltage bus is directly coupled to the switch, a second sensor coupled to the local bus, a plurality of loads coupled to the local bus and a local controller coupled to the first sensor, the second sensor and the switch.

The local controller comprises a power regulator providing power for the local controller, a sampling unit configured to detect operational parameters of the main grid system and a micro-grid system, a processor coupled to the sampling unit, an input and output unit coupled to the processor, an interface unit coupled to the processor and a communication unit coupled to the processor.

In accordance with yet another embodiment, a method comprises receiving a plurality of digital signals, wherein the digital signals are proportional to electrical variables detected from a utility system including a micro-grid system and a main grid system, generating a control command based upon the plurality of digital signals and controlling an on/off state of a switch coupled between the main grid system and the micro-grid system based upon the control command.

An advantage of an embodiment of the present invention is that the impact of a system fault in a utility system can be isolated by disconnecting a micro-grid system from a main grid system. As a result, the quality and reliability of the micro-grid system as well as the main grid system can be improved.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a simplified circuit diagram of a power utility system in accordance with an embodiment;

FIG. 2 illustrates a block diagram of the local controller shown in FIG. 1 in accordance with an embodiment;

FIG. 3 illustrates a flowchart of managing a micro-grid from a grid-connected mode to an islanded mode in an unplanned manner in accordance with an embodiment;

FIG. 4 illustrates a flowchart of managing a micro-grid from an islanded operation mode to a grid-connected operation mode in an unplanned manner in accordance with an embodiment;

FIG. 5 illustrates a flowchart of managing a micro-grid from a grid-connected mode to an islanded mode in a planned manner in accordance with an embodiment;

FIG. 6 illustrates a flowchart of managing a micro-grid from an islanded operation mode to a grid-connected operation mode in a planned manner in accordance with an embodiment;

FIG. 7 illustrates a flowchart of managing a micro-grid from a grid-connected mode to an islanded mode when a short circuit fault occurs at the input bus of the micro-grid;

FIG. 8 illustrates a flowchart of managing a micro-grid when an over current incident is detected in the micro-grid;

FIG. 9 illustrates a flowchart of managing a micro-grid when a reverse power flow incident is detected in the micro-grid; and

FIG. 10 illustrates a simplified circuit diagram of a power utility system in accordance with another embodiment.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative of specific ways to make and use the embodiments of the disclosure, and do not limit the scope of the disclosure.

The present disclosure will be described with respect to embodiments in a specific context, a controller for connecting and disconnecting a micro-grid system from a main power utility grid. The embodiments of the disclosure may also be applied, however, to a variety of power utility systems. Hereinafter, various embodiments will be explained in detail with reference to the accompanying drawings.

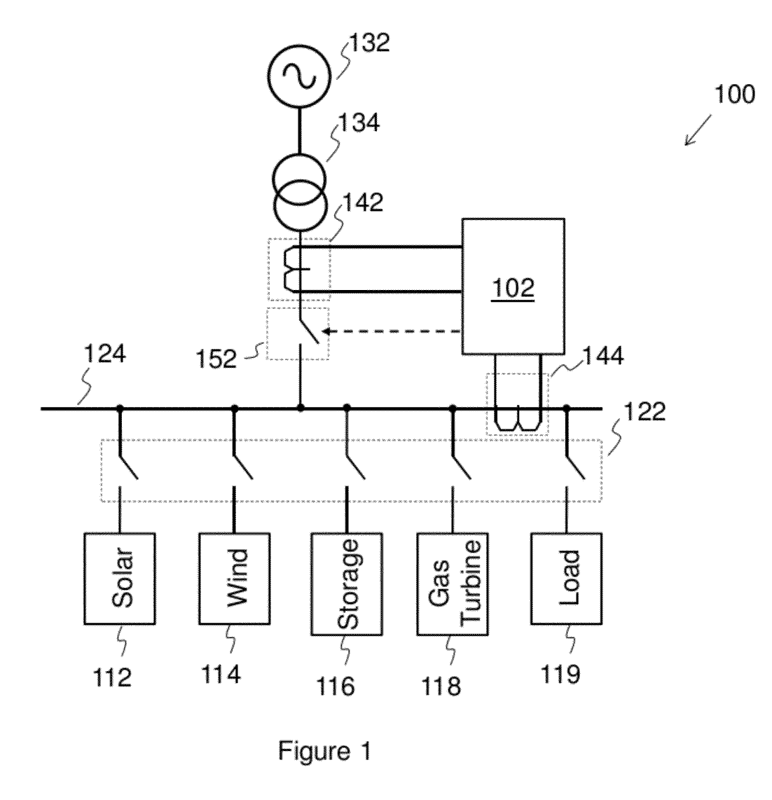

FIG. 1 illustrates a simplified circuit diagram of a power utility system in accordance with an embodiment. The power utility system 100 comprises a main grid system and a micro-grid system. The main grid system may comprise a plurality of power generators, transmission lines and loads (not shown respectively). In order to clearly illustrate the inventive aspects of various embodiments, a power source 132 is used to represent the main grid system, especially the bus, to which the micro-grid system is coupled. In accordance with an embodiment, the main grid bus voltage represented by the power source 132 is about 22 kV. A power transformer 134 is used to convert the main grid bus voltage down to a lower alternating current (ac) voltage such as 380 V.

As shown in FIG. 1, the micro-grid system may comprise a plurality of distributed power generators such as a solar power generator 112, a wind power generator 114 and a gas turbine system 118. It should be noted while FIG. 1 illustrates that the distributed power generators are coupled to a local bus 124 through a plurality of local switches 122, the micro-grid system may comprise an interface system (not shown) between the distributed power generators and the local bus 124. In accordance with an embodiment, the interface system may comprise a power inverter and a power regulator connected in series. The power inverter and the power regulator help to transform direct current power generated by the distributed power generators (e.g., solar panels) into a regulated alternating current power.

As shown in FIG. 1, the micro-grid system may further comprise an energy storage unit 116 and a variety of loads 119. In accordance with an embodiment, the power generators (e.g., solar power generator 112), the energy storage unit 116 and the loads 119 are coupled to the local bus 124. Furthermore, as shown in FIG. 1, there may be a switch 152 coupled between the local bus 124 and the main grid system. In accordance with an embodiment, the switch 152 can be implemented by using suitable devices such as circuit breakers, contactors, thyristors and the like.

A local controller 102 is coupled to both the main grid system as well as the micro-grid system. As shown in FIG. 1, there may be a first sensor 142 coupled between the main grid system and the local controller 102. It should be noted while FIG. 1 shows the first sensor 142 is a single entity, the first sensor 142 may comprise various instrument transformers such as current transformers (CTs), potential transforms (PTs) and the like Likewise, there may be a second sensor 144 coupled between the micro-grid system and the local controller 102. The structure of the second sensor 144 may be similar to the structure of the first sensor 142, and hence is not discussed in further detail. Through the sensors 142 and 144, the local controller 102 may obtain the operational parameters of the main grid system and the micro-grid system. Depending on the operational parameters from the sensors 142 and 144, the local controller 102 is capable of enabling the micro-grid system connecting to or disconnecting from the main grid system.

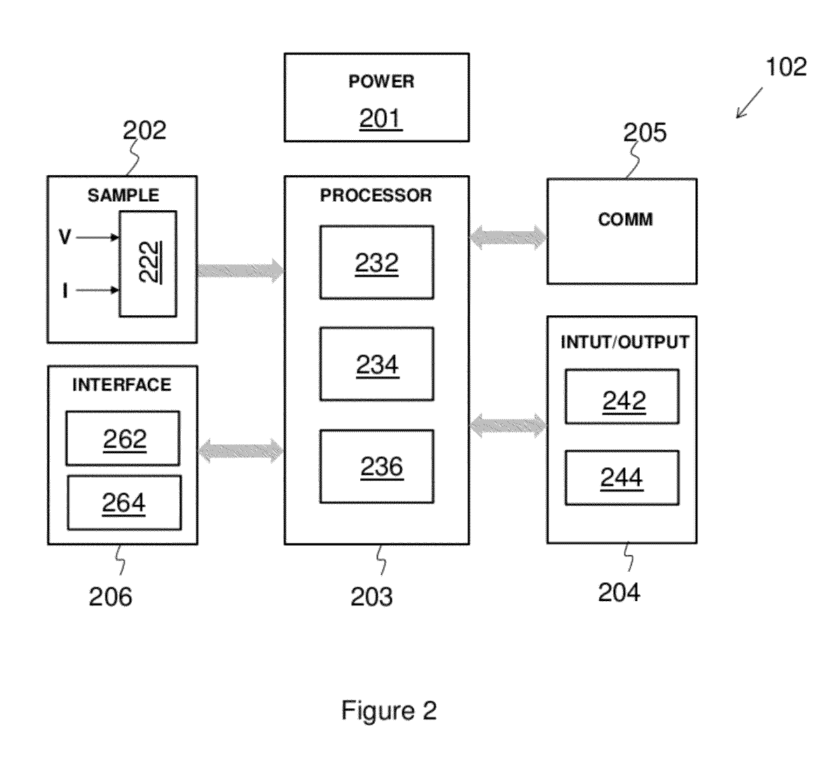

FIG. 2 illustrates a block diagram of the local controller shown in FIG. 1 in accordance with an embodiment. The local controller 102 may comprise various functional units, namely a sampling unit 202, an interface unit 206, a processor 203, an input and output unit 204, a communication unit 205 and a power regulator 201. As known in the art, the power regulator 201 is employed to provide a regulated voltage such as 3.3 V, 5 V, 12 V or the like for the other circuits of the local controller 102. The power regulator 201 can be implemented by using suitable power topologies such as isolated power converters and the like.

The sampling unit 202 is coupled to the sensors (e.g., the first sensor 142 and the second sensor 144) shown in FIG. 1. In particular, the sampling unit 202 is coupled to the first sensor 142, which is employed to detect the operational parameters of the main grid. In addition, the sampling unit 202 is further coupled to the second sensor 144, which is employed to detect the operational parameters of the local bus of the micro-grid system. In accordance with an embodiment, the operational parameters of the main grid and the micro-grid systems include voltage and current. The voltage and current signals can be obtained by using current transformers and potential transformers. It should be noted that the sampling unit 202 may obtain more operational parameters such as frequency and the like by employing other instrument sensors.

The sampling unit 202 may further comprise an analog-to-digital converter 222. The detected signals from the buses of the main grid and the micro-grid systems are scaled down to a suitable level through current and potential transformers (not shown respectively). However, the scaled down signals cannot be fed to the processor 203 directly because they are analog signals, which cannot be processed by logic circuits such as the processor 203. The analog-to-digital converter 222 is employed to convert the scaled down analog signals into their corresponding digital signals.

The processor 203 is coupled to the sampling unit 202 and receives the detected signals from the sampling unit 202. The processor 203 comprises three functional units in accordance with an embodiment. A calculation unit 232 is capable of performing various data processing functions such as fast Fourier analysis. Through the calculation unit 232, more electrical characteristics of the detected signals can be retrieved. For example, Fourier transform allows the processor 203 to obtain the harmonic and frequency information of the main grid and the micro-grid systems.

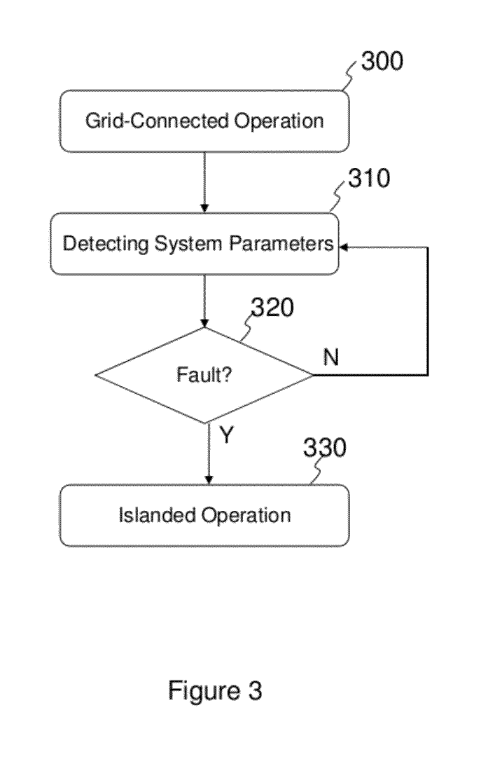

A comparison unit 234 is coupled to the calculation unit 232. The operational parameters of the micro-grid and main grid systems are sent to the comparison unit 234 from the calculation unit 232. Based upon a plurality of predetermined threshold values saved in the processor 203, the comparison unit 234 compares the operational parameters with their corresponding thresholds. The comparison results are sent from the comparison unit 234 to a processing unit 236. The processing unit 236 is capable of determining whether a failure has occurred and generating control commands to prevent the failure from impacting the quality and reliability of the utility systems. The detailed operation of the processing unit 236 will be described below with respect to FIG. 3 to FIG. 9.

The processor 203 is further coupled to a communication unit 205, an interface unit 206 and the input/output unit 204. The communication unit 205 may receive the control commands from the processor 203, and then forward the control commands to a central control system of the micro-grid. The central control system may coordinate the power generators and loads of the micro-grid based upon the control commands. For example, during a power outage of the main grid, the processor 203 may send a grid disconnect command. In response to this command, the central control system of the micro-grid may increase the power from the power generators and reduce the power consumption of the loads so as to maintain the stability of the micro-grid system.

The interface unit 206 is capable of illustrating the status of the micro-grid. In addition, the interface unit 206 may provide an input interface for manual commands. For example, a manual system connect command can be forwarded to the processor 203 through the interface unit 206.

The input and output unit 204 includes an input module 242 and an output module 244. The input module 242 is capable of detecting the status of the switch 152 through a plurality of sensors. The input module 242 not only detects the on and off state of the switch 152 (not shown but illustrated in FIG. 1), but also obtains other relevant information for controlling the switch 152. For example, a spring loaded device (not shown) is an auxiliary device for turning on/off the switch 152. The input module 242 is capable of detecting the energy level of the spring loaded device.

The output module 244 is employed to convert the control command from the processor 203 to a control signal fed to a driver coupled to the switch 152. Such a control signal is configured such that the switch 152 is turned off when the control signal is in a first logic state and the switch 152 is turned on when the control signal is in a second logic state. In accordance with an embodiment, when a power outage occurs at the main grid, the processor detects the power outage and sends a grid disconnect control command. In response to such a grid disconnect control command, the output module 244 generates a control signal, which can turn off the switch 152 through a driver coupled to the switch 152.

After the switch 152 is turned off, the off state of the switch 152 is detected by the input and output unit 204. Furthermore, the input and output unit 204 sends the status of the switch 152 to the processor 203. As such, the processor 203 acknowledges the islanded mode and sends the state of the islanded operation to its adjacent grids through the communication unit 205.

One advantageous feature of having the local controller 102 in the micro-grid system is that the local controller 102 may be fully sealed, and the high power portion such as the voltage bus and low power portion such as logic circuits of the local controller 102 are fully isolated. As a result, the local controller 102 is insensitive to noise interference. In addition, the local controller 102 is of various features such as self-testing, remote telemetry, fault recording and the like.

FIG. 3 illustrates a flowchart of managing a micro-grid from a grid-connected mode to an islanded mode in an unplanned manner in accordance with an embodiment. At step 300, the micro-grid is in grid-connected operation. At step 310, the local controller of the micro-grid keeps detecting the system operational parameters. As described above with respect to FIG. 2, the system operational parameters include the voltage and current information of both the micro-grid and the main grid.

At step 320, the processor of the local controller analyzes the voltage and current information. By analyzing the voltage and current information, the processor may find some failures or abnormal system behavior such as grid over/under frequency, grid over/under voltage, abnormal positive sequence component values, harmonic distortion and the like. Furthermore, the processor determines whether a fault occurs. If the result shows a fault has not occurred yet, the local controller proceeds with step 310 again. On the other hand, if the result shows a fault has occurred, the local controller proceeds with step 330, wherein the switch coupled between the main grid and the micro-grid is turned off. As a result, the micro-grid enters into the islanded operation mode.

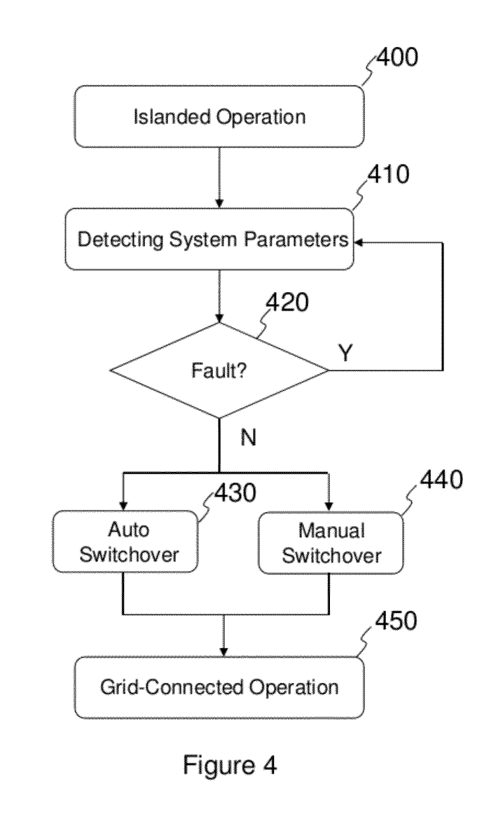

FIG. 4 illustrates a flowchart of managing a micro-grid from an islanded operation mode to a grid-connected operation mode in an unplanned manner in accordance with an embodiment. At step 400, the micro-grid is in grid-disconnected operation. In other words, the switch between the micro grid and the main grid is turned off. The micro-grid operates in an islanded operation mode. At step 410, the local controller of the micro-grid keeps detecting the system operational parameters. As described above with respect to FIG. 2, the system operational parameters include the voltage and current information of both the micro-grid and the main grid.

At step 420, the processor of the local controller analyzes the voltage and current information. Furthermore, the processor determines whether a fault still exists. If the result shows a fault still exists, the local controller proceeds with step 410 again. On the other hand, if the result shows a fault does not exist, the local controller proceeds with either step 430 or step 440 depending on a predetermined system setup. At step 430, the switch coupled between the main grid and the micro-grid is automatically turned on. On the other hand, if the local controller proceeds with step 440, wherein the local controller waits for a command from the interface unit. After receiving a manual switchover command, the local controller turns on the switch through the driver coupled to the switch.

It should be noted that the switch coupled between the micro-grid system and the main grid system may be triggered by either an electronic driver or a manual driver. In an automatic switchover process, the switch is turned on/off through an electronic driver. On the other hand, in a manual switchover process at step 440, as described above, the switch may be turned on/off through an electronic driver. In addition, the manual switchover of step 440 may comprise a turn-on process through a manual switchover of the switch coupled between the micro-grid system and the main grid system. As a result, at step 450, the micro-grid enters into the grid-connected operation mode.

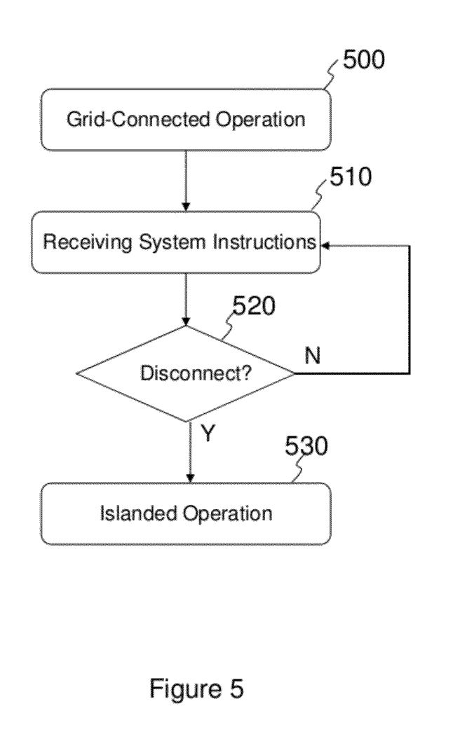

FIG. 5 illustrates a flowchart of managing a micro-grid from a grid-connected mode to an islanded mode in a planned manner in accordance with an embodiment. At step 500, the micro-grid is in grid-connected operation. At step 510, the local controller of the micro-grid keeps receiving system instructions from a control center such as a power dispatch center of the main grid. Referring back to FIG. 1, in a utility system comprising a main grid system and a micro-grid system, the power dispatch center of the main grid, in order to prevent an unstable operation, may force the micro-grid to disconnect from the main grid when a failure or abnormal system behavior occurs in the main grid. The grid-disconnected command from the power dispatch center to the local controller of the micro-grid system is commonly referred to as a planned islanded operation mode.

At step 520, the local controller determines whether there is a command of changing from a grid-connected mode to an islanded mode in the system instructions. If the power dispatch center does not instruct the local controller to disconnect from the main grid, the local controller proceeds with step 510 again. On the other hand, if the dispatch center instructs the local controller to disconnect from the main grid, the local controller proceeds with step 530, wherein the switch coupled between the main grid and the micro-grid is turned off. As a result, the micro-grid enters into the islanded operation mode.

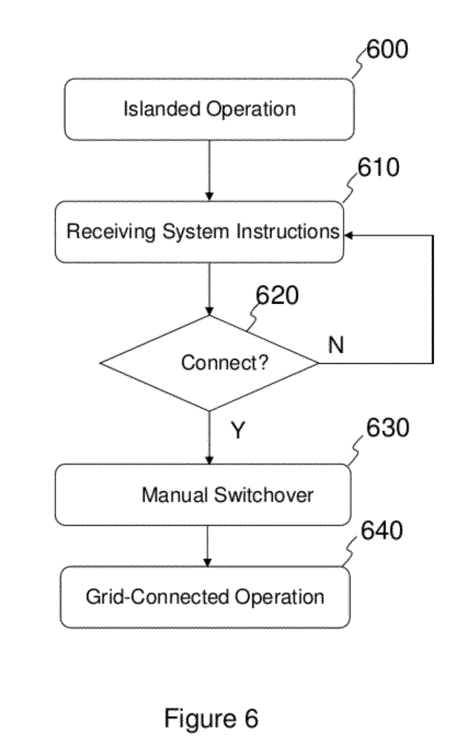

FIG. 6 illustrates a flowchart of managing a micro-grid from an islanded operation mode to a grid-connected operation mode in a planned manner in accordance with an embodiment. At step 600, the micro-grid is in grid-disconnected operation. In other words, the micro-grid operates in an islanded operation mode. At step 610, the local controller of the micro-grid keeps receiving system instructions from a power dispatch control center located at the main grid.

At step 620, the local controller determines whether there is a command of changing from a grid-disconnected mode to a grid-connected mode in the system instructions. If the power dispatch control center does not instruct the local controller to connect to the main grid, the local controller proceeds with step 610 again. On the other hand, if the power dispatch control center instructs the local controller to connect to the main grid, the local controller proceeds with step 630, wherein the switch coupled between the main grid and the micro-grid is turned on in a manual switchover manner. As a result, the micro-grid enters into the grid-connected operation mode. It should be noted that in a planned grid-connected mode, the automatic switchover is disable to protect the micro-grid system.

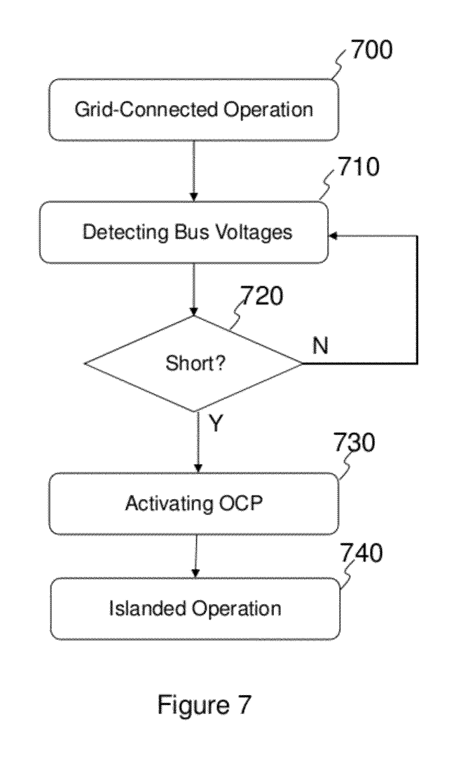

FIG. 7 illustrates a flowchart of managing a micro-grid from a grid-connected mode to an islanded mode when a short circuit fault occurs at the input bus of the micro-grid. At step 700, the micro-grid is in grid-connected operation. At step 710, the local controller of the micro-grid keeps monitoring the input bus voltage of the micro-grid. Referring back to FIG. 1, the input bus voltage is the voltage bus directly coupled to the switch 152 when the micro-grid operates in a grid-connected mode.

At step 720, the processor determines whether a short circuit fault occurs at the input bus. If there is no short circuit occurred at the input bus, the local controller proceeds with step 710 again. On the other hand, if there is a short circuit fault occurred at the input bus, the local controller proceeds with step 730, wherein an over current protection mechanism is activated so that the quality and reliability of the micro-grid can be maintained. In addition, the switch coupled between the main grid and the micro-grid may be turned off. As a result, the micro-grid enters into the islanded operation mode.

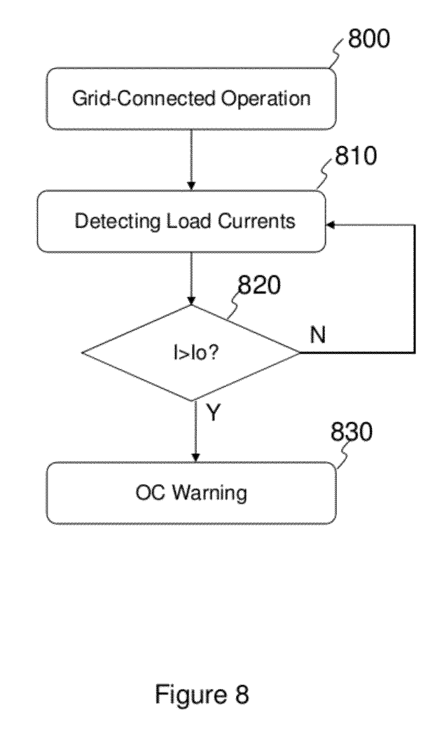

FIG. 8 illustrates a flowchart of managing a micro-grid when an over current incident is detected in the micro-grid. At step 800, the micro-grid is in grid-connected operation. At step 810, the local controller of the micro-grid keeps monitoring the currents of the local bus as well as the various loads coupled to the local bus. At step 820, the processor determines whether an over current incident occurs. If an over current incident has not occurred in the micro-grid, the local controller proceeds with step 810 again. On the other hand, if there is an over current incident occurred in the micro-grid, the local controller proceeds with step 830, wherein an over current warning is activated so that the quality and reliability of the micro-grid can be maintained.

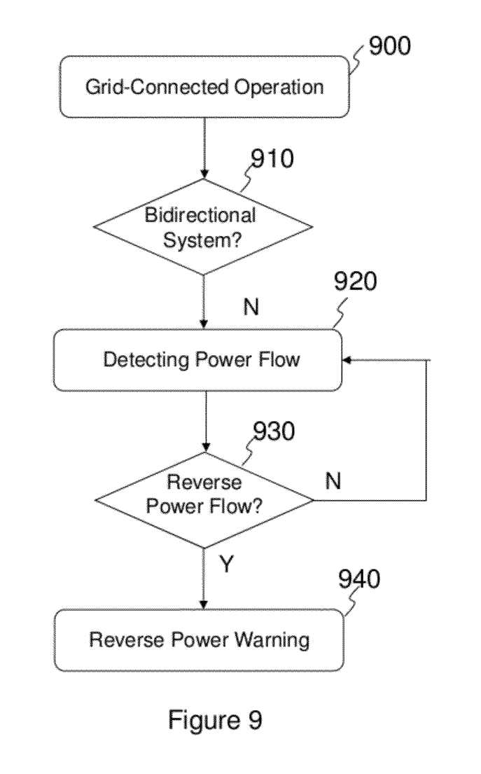

FIG. 9 illustrates a flowchart of managing a micro-grid when a reverse power flow incident is detected in the micro-grid. At step 900, the micro-grid is in grid-connected operation. At step 910, the local controller determines whether the utility system to which the micro-grid is coupled is a bidirectional system. If the utility system does not allow a bidirectional power flow mode. The local controller further proceeds with step 920, wherein the local controller of the micro-grid keeps monitoring the direction of the power flow between the main grid and the micro-grid. In accordance with an embodiment, a reverse power flow is defined as power flowing from the micro-grid system to the main grid system.

At step 920, the processor determines whether a reverse power flow occurs. If a reverse power flow does not exist, the local controller proceeds with step 910 again. On the other hand, if there is a reverse power flow between the main grid and the micro-grid, the local controller proceeds with step 930, wherein a reverse power flow warning is activated so that the power output of each power generator can be adjusted. As a result, the quality and reliability of the micro-grid can be maintained.

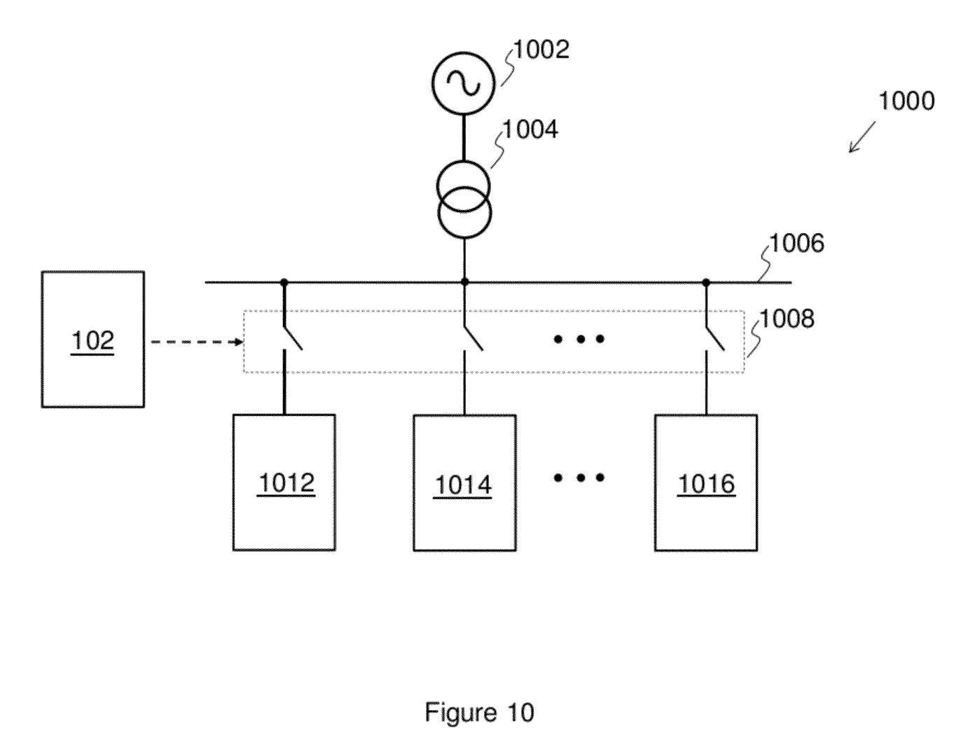

FIG. 10 illustrates a simplified circuit diagram of a power utility system in accordance with another embodiment. In the power utility system 1000, there may be a plurality of micro-grid systems such as micro-grids 1012, 1014 and 1016. The micro-grids are coupled to the bus 1006 of the main grid through their respective switches 1008. A local controller 102 may be shared by the plurality of micro-grid systems. In other words, the local controller 102 controls the on and off states of the plurality of switches 1008. As a result, each micro-grid system may operates in an islanded mode or a grid-connected mode depending on the on and off state of its switch coupled to the bus 1006.

The detailed operation principle of the local controller 102 in FIG. 10 is similar to that of the local controller shown in FIG. 1, and hence is not discussed in further detail to avoid unnecessary repetition. One advantageous feature of having a local controller coordinating a plurality of micro-grid systems is that the local controller is able to disconnect a micro-grid system, wherein a fault occurs from the bus 1006 so that the power quality and reliability of other micro-grids tied to the bus 1006 can be maintained.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus comprising:
a sampling unit configured to detect operational parameters of a main grid system and a micro-grid system;
a processor coupled to the sampling unit, wherein the processor is configured to:
receive the operational parameters of the main grid system and the micro-grid system;
generate a control signal for the micro-grid system in consideration with planned islanded operation, unplanned islanded operation, system faults, short circuit, over current and reverse power flow; and
forward the control signal to a driver of a switch coupled between the main grid system and the micro-grid system; and
an input and output unit coupled to the processor, wherein the input and output unit is configured to:
detect an operating status of the switch;
forward the operating status to the processor; and
execute a control command from the processor.

2. The apparatus of claim 1, further comprising:
an interface unit coupled to the processor, wherein the interface unit is configured to:
receive a manual switchover command; and
display system operational parameters.

3. The apparatus of claim 1, further comprising:
a communication unit coupled to the processor, wherein the communication unit is configured to communicate with a central power dispatch center.

4. The apparatus of claim 1, further comprising:
a power regulator, wherein the power regulator converts a high voltage into a lower voltage suitable for logic circuits.

5. The apparatus of claim 1, wherein the sampling unit comprises an analog-to-digital converter capable of converting detected voltage and current signals to various digital signals suitable for the processor.

6. The apparatus of claim 1, wherein the processor comprises:
a calculation unit receiving digital signals from the sampling unit, wherein the calculation unit generates a plurality of system operational variables based upon the digital signals;
a comparison unit coupled to the calculation unit, wherein the comparison unit compares the system operational variables with their corresponding thresholds; and
a processing unit coupled to the comparison unit, wherein the processing unit generates the control signal based upon a comparison result generated by the comparison unit.

7. The apparatus of claim 6, wherein the calculation unit processes the digital signals using a fast Fourier transform process.

8. A system comprising:
a local voltage bus coupled to a main grid system through a switch;
a plurality of power generators coupled to the local voltage bus;
a plurality of power storage units coupled to the local voltage bus;
a first sensor coupled to a main grid voltage bus, wherein the main grid voltage bus is directly coupled to the switch;
a second sensor coupled to the local voltage bus;
a plurality of loads coupled to the local voltage bus; and
a local controller coupled to the first sensor, the second sensor and the switch, wherein the local controller comprises:
a power regulator providing power for the local controller;
a sampling unit configured to detect operational parameters of the main grid system and a micro-grid system;
a processor coupled to the sampling unit;
an input and output unit coupled to the processor;
an interface unit coupled to the processor; and
a communication unit coupled to the processor.

9. The system of claim 8, wherein the processor is configured to:
receive the operational parameters of the main grid system and the micro-grid system;
generate a control signal for the micro-grid system in consideration with planned islanded operation, unplanned islanded operation, system faults, short circuit, over current and reverse power flow; and
forward the control signal to a driver of the switch coupled between the main grid system and the micro-grid system.

10. The system of claim 8, wherein the input and output unit is configured to:
detect an operating status of the switch;
forward the operating status to the processor; and
execute a control command from the processor.

11. The system of claim 8, wherein the power generators are selected from a group consisting of solar energy sources, wind generators, combined heat and power (CHP) systems, marine energy, geothermal, biomass, fuel cells, micro-turbines, and any combination thereof.

12. The system of claim 8, wherein the power storage units are selected from a group consisting of utility-scale energy storage systems, batteries, and any combination thereof.

13. The system of claim 8, wherein the switch is implemented by a device selected from a group consisting of breakers, contactors, thyristors, and any combination thereof.

14. The system of claim 8, further comprising a power dispatch center located in the main grid system, wherein the power dispatch center is configured to communicate with the local controller.

15. A method comprising:
receiving a plurality of digital signals, wherein the digital signals are proportional to electrical variables detected from a utility system including a micro-grid system and a main grid system;
generating a control command based upon the plurality of digital signals; and
controlling an on/off state of a switch coupled between the main grid system and the micro-grid system based upon the control command.

16. The method of claim 15, further comprising:
detecting a fault in the utility system; and
disconnecting the micro-grid system from the main grid system by turning off the switch.

17. The method of claim 15, further comprising:
receiving an islanded operation command from a power dispatch center located at the main grid system;
disconnecting the micro-grid system from the main grid system by turning off the switch;
receiving a grid-connected operation command from the power dispatch center located at the main grid system; and
connecting the micro-grid system to the main grid system by turning on the switch.

18. The method of claim 15, further comprising:
detecting a short circuit incident at a voltage bus in the utility system, wherein the voltage bus is coupled between the main grid system and the micro-grid system;
activating an over-current protection mechanism; and
disconnecting the micro-grid system from the main grid system by turning off the switch.

19. The method of claim 15, further comprising:
detecting an over-current incident in the micro-grid system; and
sending an over-current warning to the utility system.

20. The method of claim 15, further comprising:
detecting a reverse power flow between the micro-grid system and the main grid system; and
sending a reverse power flow warning to the utility system.
